(19) United States
(12) Patent Application Publication
(10) Pub. No.: US 2003/0175015 A1
(43) Pub. Date: Sep. 18, 2003

(54) Information storage medium in which audio associated information is recorded, and information recording/reproducing method

(75) Inventors: Hideo Ando, Hino-shi (JP); Kazuhiko Taira, Yokohama-shi (JP); Hideki Mimura, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/387,491

(22) Filed: Mar. 14, 2003

(30) Foreign Application Priority Data
Mar. 15, 2002 (JP) 2002-072926

(51) Int. Cl. H04N 5/76

(52) U.S. Cl. 386/95; 386/96

(57) ABSTRACT

There is disclosed an information storage medium in which music associated information including a data structure is recorded. The structure includes a recording region including a first recording region in which the audio information coded by a first coding mode is recorded and a second recording region in which the audio information coded by a second coding mode is recorded, and a management region in which management information concerning the recording region is recorded and which includes reproduction procedure information indicating a reproduction procedure of audio associated information. There are also disclosed an information reproduction apparatus, information recording apparatus, and methods in which the information storage medium is handled.

### CROSS-REFERENCE TO RELATED APPLICATIONS

This application is based upon and claims the benefit of priority from the prior Japanese Patent Application No. 2002-072926, filed Mar. 15, 2002, the entire contents of which are incorporated herein by reference.

### BACKGROUND OF THE INVENTION

1. Field of the Invention

The present invention relates to an information recording/reproducing method, particularly to an information recording/reproducing apparatus and method in which music associated information is handled, computer program, information storage medium, and data structure. And, present invention refers to an information recording/reproducing apparatus for the method.

2. Description of the Related Art

In recent years, a compact disk digital audio (CD-DA) and magneto-optical disk (MD) have been presently well known as disc-shaped information storage medium (optical disk) in which audio associated information is recorded.

As a recording format of CD-DA, as described in Digital AV Standard Guidebook (1994, Ohmsha) p.8, General Multimedia Sampler edited by the Society of Television, audio object (sound) information is recorded on a disk in a linear PCM form, and management information concerning the recorded audio object (sound) information is recorded in a management region referred to as a table of contents (TOC).

Moreover, as the recording format of MD, as described in Digital Broadcasting Technical Subject-Book of the Multimedia Age (1994, Maruzen Co., Ltd.) p. 127 edited by NHK Broadcasting Technical Research Institute, the audio object (sound) information is compressed in a compression method referred to as adaptive transform Acoustic Coding (ATRAC) and recorded on the disk, and the management information concerning the recorded audio object (sound) information is similarly recorded in the management region referred to as the table of contents (TOC).

For either CD-DA or MD, the audio object (sound) information is recorded into a disc-shaped information storage medium in a unique form (coding mode) referred to as linear pulse code modulation (linear PCM) or adaptive transform acoustic coding (ATRAC). Accordingly, since a decode circuit of linear PCM is incorporated in all CD players, reproduction compatibility of the audio object (sound) information recorded in accordance with the standard of CD-DA is secured in any CD player. Similarly, since the decode circuit adapted for the ATRAC is incorporated in all MD players, the reproduction compatibility is secured with respect to the audio object (sound) information recorded in the MD disk.

In recent years, electronic distribution of the audio object (sound) information has been actively performed. This is a system in which the compressed audio object (sound) information is distributed via a telephone or Internet line, and fee is charged in accordance with an amount of received information. A user temporarily stores the received audio object (sound) information in a memory card or MD disk, and it becomes possible to reproduce audio information (audio object) from the memory card (or MD) in which the information is temporarily stored a number of times.

The information compression method of the audio object (sound) information at a distribution time differs with a distributor, and various types of compression methods have been used such as motion picture experts group (MPEG) Audio_Layer II, ATRAC3, audio code number 3 (AC-3) developed by Dolby, and advanced audio coding (AAC). Therefore, the audio player of the memory card cannot reproduce the information depending on the compression method of the distributor in some case.

At present in DCD forum an audio recording standard has been studied. As a purpose of an optical disk (recordable DVD disk) in which the audio information is recorded in accordance with the standard, a method is brought into view which comprises: “(1) temporarily storing electronically distributed audio associated information in the optical disk, and re-recording a part of the audio associated information stored in the optical disk into the memory card as such or by editing the part.” To use the disk for this purpose, there is a strong demand for the recording of the audio object (sound) information without changing a form by the information compression method at a distribution time. Additionally, a purpose for “(2) recording the audio associated information with an exclusive-use recorder for household, and reproducing the audio associated information stored in the optical disk with an exclusive-use player for household” is also studied.

An example will be described in which the audio object (sound) information keeping the form by the information compression method (coding mode) at the distribution time is recorded in the optical disk in accordance with the above-described purpose (1). In this case, even when this optical disk is carried for the above-described purpose (2), and the recorded audio object (sound) information is reproduced with the exclusive-use player for household, the information cannot be reproduced (the reproduction compatibility among the players cannot be secured). Because the information is recorded in a special information compression method (coding method).

On the other hand, a related art of an optical disk apparatus in which a compatible linear PCM is used to reproduce the audio information is disclosed in Jpn. Pat. Appln. KOKAI Publication No. 1999-120748. For the optical disk apparatus disclosed in the publication, the audio information by the linear PCM having compatibility among the players is an object. As long as the audio information is handled, the compatibility is secured among the players, and the information can freely be reproduced. However, the audio information by an exclusive-use coding mode which does not have the compatibility is not the object. With respect to the audio information which can be reproduced only with the exclusive-use player, there is a problem that the information cannot be reproduced with the compatibility among many players.

That is, the conventional apparatus has a compatibility problem that the audio information recorded in recording mediums such as the optical disk in a peculiar information compression method (coding method) cannot be reproduced with another player.

### BRIEF SUMMARY OF THE INVENTION

An embodiment of the present invention may provide a recording/reproducing method of audio associated information into an information storage medium, in which electronically distributed audio associated information can be recorded in an optical disk in a form by an information compression method at a distribution time as such, and in which additionally audio information is generated and recorded even in an information compression method (coding mode) to secure compatibility of reproduction among different players. And, the embodiment refers to an information recording/reproducing apparatus for the method.

According to one aspect of the present invention, there is provided an information storage medium in which audio associated information is recorded, the information including: a recording region in which at least audio information is recorded, the recording region including a first recording region in which the audio information coded by a first coding mode is recorded and a second recording region in which the audio information coded by a second coding mode different from the first coding mode is recorded; and a management region in which management information concerning the recording region is recorded and which includes reproduction procedure information indicating a reproduction procedure of the audio associated information, the reproduction procedure information indicating the reproduction procedure of the audio information by connection of reproduction units and in which the audio information is managed as the reproduction units different from one another in the first and second recording regions and which includes coding mode information to be referred to in reproducing the audio information.

In the information storage medium of the present invention, as described above, the audio information is recorded in a unique audio coding mode (α). Additionally, the same audio information is recorded in the information storage medium even in an audio coding mode (β) of a linear PCM, in which the information can be reproduced with all players. Thereby, a user can reproduce even the audio information heretofore coded in the unique audio coding mode which does not have compatibility with compatibility by all players of the audio information.

According to another aspect of the present invention, there is provided an information reproduction apparatus in which music associated information recorded in an information storage medium is reproduced, comprising: readout means for reading information from an information storage medium in which the music associated information is recorded, the information including a recording region in which at least audio information is recorded, the recording region including a first recording region in which the audio information coded by a first coding mode is recorded and a second recording region in which the audio information coded by a second coding mode different from the first coding mode is recorded, and a management region in which management information concerning the recording region is recorded and which includes reproduction procedure information indicating a reproduction procedure of the audio associated information, the reproduction procedure information indicating the reproduction procedure of the audio information by connection of reproduction units and in which the audio information is managed as the reproduction units different from one another in the first and second recording regions and which includes coding mode information to be referred to in reproducing the audio information; and reproduction means for reproducing at least one of the audio information coded by the first coding mode and recorded in the first recording region and the audio information coded by the second coding mode and recorded in the second recording region based on read information read by the readout means.

For the information reproduction apparatus of the present invention, as described above, the information storage medium in which the music associated information including audio information coded in accordance with at least two coding modes is recorded is an object. Therefore, different from a conventional apparatus in which the audio information recorded in the optical disk can be reproduced only with a player using a unique coding mode as an object, the present apparatus has compatibility such that the information can be reproduced even with a player having any coding mode. Consequently, the apparatus can very conveniently reproduce the music associated information.

### BRIEF DESCRIPTION OF THE SEVERAL VIEWS OF THE DRAWING

FIG. 1 is a schematic view showing information recording and reproducing processes performed by music associated information according to one embodiment of the present invention;

FIG. 2 is a data structure diagram showing a detailed data structure of the music associated information according to one embodiment of the present invention;

FIG. 3 is a directory diagram showing an outline of directory of the music associated information according to one embodiment of the present invention;

FIG. 4 is a block diagram showing one example of an information recording/reproducing apparatus according to one embodiment of the present invention;

FIG. 5 is a flowchart showing one example of the recording process of the information recording/reproducing apparatus according to one embodiment of the present invention; and

FIG. 6 is a flowchart showing one example of the reproducing process of the information recording/reproducing apparatus according to one embodiment of the present invention.

### DETAILED DESCRIPTION OF THE INVENTION

An embodiment of the present invention will be described hereinafter in detail with reference to the drawings.

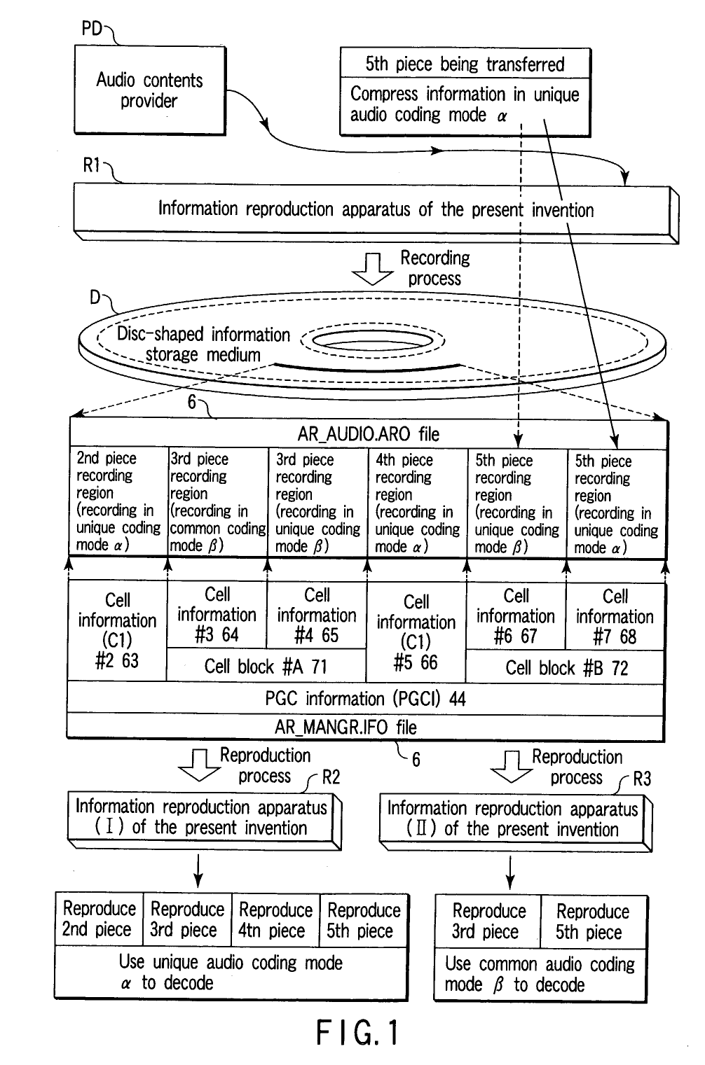

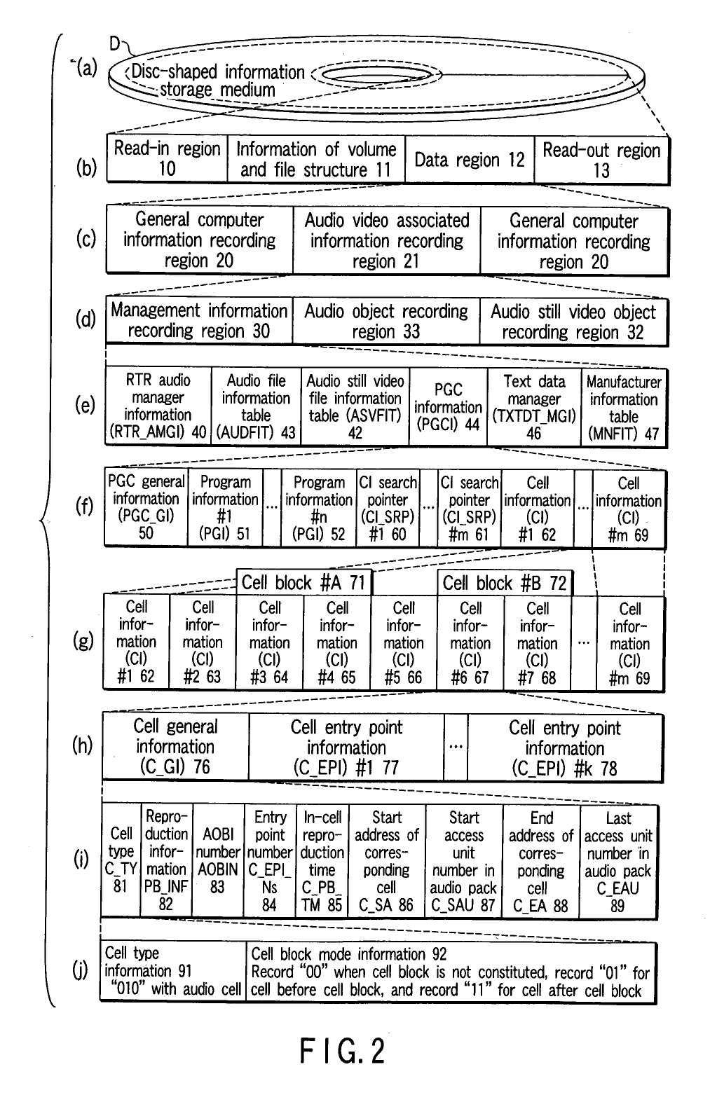

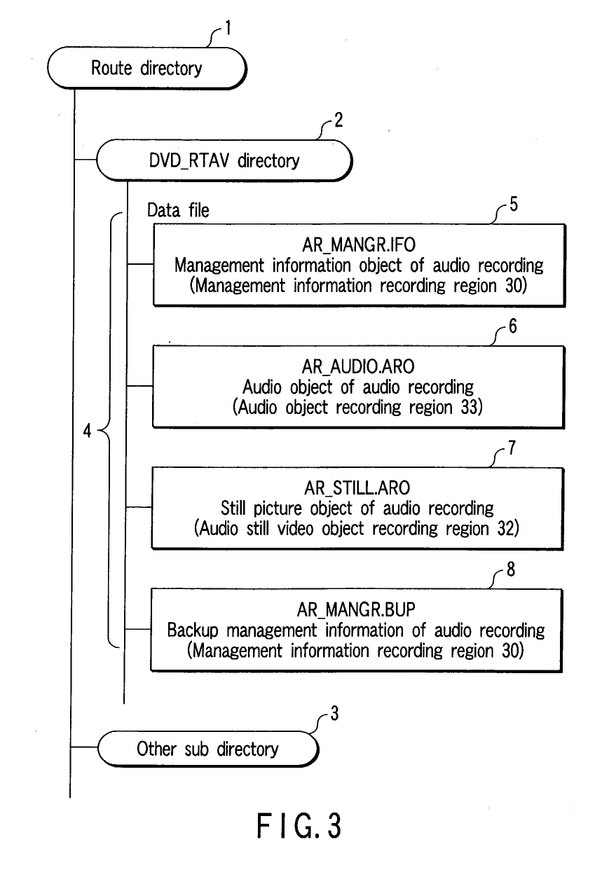

FIG. 1 is a schematic view showing information recording and reproducing processes performed by music associated information according to one embodiment of the present invention, FIG. 2 is a data structure diagram showing a detailed data structure of the music associated information according to one embodiment of the present invention, and FIG. 3 is a directory diagram showing an outline of directory of the music associated information according to one embodiment of the present invention.

<Point of Music Associated Information According to the Present Invention>

A point of music associated information according to one embodiment of the present invention is represented as a combination of the following (a) to (f).

(a) A linear PCM and packed PCM are set as coding methods (coding modes) which can necessarily be reproduced with any player.

Since audio object (sound) information recorded in an information storage medium in the above-described two types of common coding methods (coding modes) can be reproduced with all players, reproduction compatibility can be secured.

(b) Electronically distributed audio object (sound) information is recorded in the information storage medium as a first coding mode in a form of an information compression method (coding mode) at a distribution time as such.

(c) Simultaneously with the above (b), the electronically distributed audio object (sound) information is re-coded in a common coding mode defined by (a), and stored as a second coding mode in the information storage medium.

(d) The management information with respect to the audio object (sound) information is managed by program chain (PGC) indicating a reproduction procedure by connection of one or more cells. The respective audio object (sound) information recorded in the first and second coding modes described in the above (b) and (c) are allowed to belong to cells (or programs) different from each other. These two cells (programs) form a pair and constitute a cell block (or program block).

(e) In PGC information in which information concerning PGC is described, information on the cell (or program) corresponding to the audio object (sound) information recorded in the second coding mode as a common coding mode is first described. Then, information on the cell (or program) corresponding to the audio object (sound) information recorded in the first coding mode as a unique coding mode is described.

(f) In cell information in which information on the cell is recorded, information is described indicating “whether or not the corresponding cell constitutes the cell block” and indicating “the first described cell (corresponding to the common coding mode) or the later described cell (corresponding to the unique coding mode), when the corresponding cell constitutes the cell block”.

Moreover, the player reproduces the information in the cell block (or program block) in the PGC, and reproduces only the audio object (sound) information designated by only one of the cell information described before or after in accordance with the coding mode corresponding to the reproduction.

<Concrete Description of Embodiment>

An operation principle of an information recording/reproducing apparatus or information reproduction apparatus in the present invention will be described with reference to FIG. 1.

In FIG. 1, compressed audio object (sound) information is distributed from an audio contents provider PD via a telephone or Internet line. As described above, an information compression method of the audio object (sound) information at the distribution time differs with a distributor, and various types of compression methods are used. Here, a fifth piece of music is transferred while the information is compressed in a unique audio coding mode α.

To record this information in a disc-shaped information storage medium D, as shown in FIG. 3, whole audio information (audio object) is recorded into an AR_AUDIO.ARO file 6. The transferred audio information of first to fifth pieces is recorded in the unique audio coding mode α at a transfer time as such. Moreover, in parallel with this, in the embodiment shown in FIG. 1, the third and fifth pieces are re-encoded and recorded in a common audio coding mode β so that the pieces can be reproduced (decoded) with any player in common. This is a great characteristic of the present invention.

The characteristics of the management information concerning the audio object recorded on the information storage medium D in this manner will be described hereinafter. In the embodiment shown in FIG. 1, the same audio information is recorded twice as the third and fifth pieces of music in different audio coding modes. The cells are divided in the management for each audio coding mode to constitute the cell block for the same piece. That is, the audio information of the third piece recorded in different audio coding modes are associated with cell information #3_64 and #4_65, and these two cell information are assembled to constitute one cell block #A71.

To reproduce the information from the information storage medium D in which the information is recorded with the information reproduction apparatus (player), in an information reproduction apparatus (I)R2 in which a decode circuit for the unique audio coding mode α is disposed, the audio coding mode α is used to reproduce the information, and therefore the first to fifth pieces can continuously be reproduced.

On the other hand, in an information reproduction apparatus (II)R3 in which the decode circuit for the unique audio coding mode α is not disposed, the common coding mode β is used to reproduce the information, and therefore only the first and fifth pieces in which the information is recorded are reproduced.

FIG. 2 shows management information contents recorded on the information storage medium D according to the embodiment of the present invention.

The disc-shaped information storage medium D shown in (a) in FIG. 2 includes a read-in region 10, information of volume and file structures 11, data region 12, and readout region 13.

In the data region 12 as a region in which the user can record the information in the rewritable disc-shaped information storage medium D, a format is disposed in which a general computer information recording region 20 and audio/video associated information recording region 21 can exist in a mixed manner. Audio/video contents information is referred t as an object, and audio contents information (audio object information) is recorded in an audio object recording region 33. In the embodiment of the present invention, simultaneously with audio information (audio object) reproduction, an still image (audio/still video object) can be displayed. In the present invention, the still image is recorded in an audio/still video object recording region 32. In the embodiment of the present invention, the audio information (audio object), still image information (audio/still video object), and text information associated with the audio information are generically referred to as “audio associated information”. Contents of these object information (contents information), attribute information, and control information for the display are recorded together in a management information recording region 30 as shown in (d) in FIG. 2.

Each object information (contents information) is recorded in each one independent file for each object content. That is, as shown in FIG. 3, the whole audio information (audio object) is recorded together in the AR_AUDIO.ARO file 6, and whole still image information (still picture) is recorded together in an AR_STILL.ARO file 7. The information in the management information recording region 30 in which these object files are generally managed is recorded in the AR_AUDIO.ARO file 6 and an AR_MANGR.BUP file 8 as a backup file of the file 6. Moreover, a region recorded as the AR_AUDIO.ARO file 6 on the information storage medium D corresponds to the audio object recording region 33, and a region recorded as the AR_STILL.ARO file 7 on the information storage medium D corresponds to the audio/still video object recording region 32.

As shown in (e) in FIG. 1, a framework portion of the data structure of the management information recorded in the information storage medium in which audio recording (or recording)/reproducing is possible with respect to the audio associated information includes a structure similar to that of a video recording standard established in DVD forum, while compatibility is regarded as important. Manager information common in the management information recording region 30 is recorded in RTR audio manager information (RTR_AMGI) 40, and the management information concerning the audio object in the audio object recording region 33 disposed in the AR_AUDIO.ARO file 6 is recorded in an audio file information table (AUDFIT) 43. Moreover, the management information concerning the audio/still video object in the audio/still video object recording region 32 disposed in the AR_STILL.ARO file 7 is recorded in an audio/still video file information table (ASVFIT) 42. Text information associated with the audio information constituting the audio associated information is organized and recorded in a text data manager (TXTDT_MG) 46. Furthermore, a manufacturer information table (MNFIT) 47 is disposed.

Furthermore, PGC information 44 includes PGC general information (PGC_GI) 50, program information #1 to n (PGI) 51, 52, CI search pointers (CI_SRP) #1 to n_60, 61, and cell information (CI) #1 to m_62 to 69.

Here, similarly as the standard established by the DVD forum in September, 1999, information indicating reproduction procedure of the audio associated information is recorded in the PGC information (PGCI) 44. That is, a minimum basic unit continuously reproduced in the audio associated information to be reproduced is referred to as a cell, and a program chain (PGC) is constituted as the reproduction procedure as a connection of the cell. The management information concerning the cell is all recorded in cell information (CI) #1_62 to #m_69 recorded in the management information recording region 30. Information indicating a range reproduced by one cell in the AR_AUDIO.ARO file 6 in which the audio information (audio object) is recorded is recorded in the cell information (CI) #1_62 to #m_69. For the reproduction procedure of the audio associated information to be reproduced in accordance with one PGC information, basically the information is reproduced/displayed in an arrangement order of the cell information (CI) #1_62 to #m_69 constituting the PGC information (PGCI) 44 as shown in (f) in FIG. 1. However, when the corresponding cells constitute cell blocks #A_71, #B_72, the player reproduces only one pair of cells #3_64 and #4_65 or #6_67 and #7_68 constituting the cell blocks #A_71, #B_72 in accordance with the audio coding mode for the decoder disposed in the player.

The CI search pointers (CI_SRP) #1_60 to #m_61 shown in (f) in FIG. 2 designate first address information in which the corresponding cell information is recorded, and secure high-speed access to each cell information. For example, the CI search pointer (CI_SRP) #1_60 is described later, and recorded as a difference value of a relative block number from a write position of the PGC information (PGCI) 44 as a recording start address of the corresponding #1 cell information (CI) 62. Here, one block means a data size of 2 k bytes.

One program shown in (f) in FIG. 2 basically indicates a range of audio “one piece”, and is constituted of one or more cells in one program. In the program information (PGI) #1_51 to #n_52, number information of cells included in the corresponding program is recorded, and correspondence between the program and cell is known from the information.

The data structure in the respective cell information (CI) #1_62 to #m_69 is constituted of cell general information (C_GI) 76 in which general information concerning the cell is described, and cell entry point information (C_EPI) #1_77 to #k_78. In the cell entry point information (C_EPI) #1_77 to #k_78, any one information of (1) information indicating start and range of representative audio indicating an audio content in the cell, (2) movements of symphony and song number, and index information indicating a silent period range is recorded.

When an entry point position indicating a first index position of (2) deviates from the start position in the cell, a deviating range corresponds to the silent period.

Various types of information shown in (i) in FIG. 2 are recorded in the cell general information (C_GI) 76. In the DVD forum, in the video recording standard established in September, 1999, a start/end position of the corresponding movie cell (video cell) is designated by a presentation time (PTM).

On the other hand, in the present invention, the start position of the audio cell is designated by “start address C_SA 86 of the corresponding cell” and “start access unit number C_SAU 87 in the audio pack”. The end position of the audio cell is designated by “end address C_EA 88 of the corresponding cell” and “last access unit number C_EAU 89 in the audio pack”. A great characteristic of the present invention lies in this. These four information will be described hereinafter in detail.

That is, the “start address C_SA 86 of the corresponding cell” is represented by the relative (difference) number of logical blocks to a position where the audio pack including the start position of the corresponding cell exists from the start address of the audio object (AOB) including a designated range of the corresponding cell recorded in the AR_AUDIO.ARO file 6. For the logical block number, real data is set every 2 k bytes, and one audio pack is constituted every 2 k bytes.

Moreover, in the “start access unit number C_SAU 87 in the audio pack”, the access unit means an audio frame in the linear PCM, and means a minimum compression unit of the audio object information in another compression coding mode. The real data exists every 2 k bytes.

As not shown, the audio pack is constituted of a “pack header”, “packet header”, “private header”, and “recording region (payload) of audio (object) data”. Access units are densely arranged in the payload. In a compression coding mode, each access unit size changes. Therefore, a boundary position of each payload disagrees with an access unit boundary position in many cases. The same access unit is disposed over two audio packs disposed adjacent to each other in many cases. For the access unit number, the access unit in which the end positions of the audio cells are similarly disposed over two audio packs is not counted. The access unit first completely disposed in the payload is counted as a first unit. An ordinal number of the access unit constituted by the audio information indicating the top position of the corresponding cell in the payload including the access unit is indicated. The ordinal number of the access unit in the payload in the audio pack present in the address designated by the “start address C_SA 86 of the corresponding cell” is indicated.

Furthermore, the “end address C_EA 88 of the corresponding cell” is displayed with the relative (difference) logical block number to the position where the audio pack including the access unit of the end position of the corresponding cell exists from the start address of the audio object (AOB) including the designated range of the corresponding cell recorded in the AR_AUDIO.ARO file 6.

Additionally, the “last access unit number C_EAU 89 in the audio pack” indicates the ordinal number of the complete access unit in which the audio (object) information indicating the end position of the corresponding cell is recorded in the “recording region (payload) of the audio (object) data” in the audio pack present in the address designated by the “end address C_EA 88 of the corresponding cell”. The access unit disposed over two audio packs disposed adjacent to each other is not counted.

In the embodiment of the present invention, the start and end positions of the audio cell are specified by four pieces of information.

Time map information indicating a relation between address information and reproduction time in the video object file is recorded in the management information of the video object in the video recording standard. As a result, the start/end position of the cell is indicated by presentation time (PTM), the time map information can be used to locate an access position in the video object file, and the start/end position can be designated with very fine precision.

On the other hand, in the present invention the time map information is not disposed in the audio file information table (AUDFIT) 43. When the audio (audio object) information all of the compression coding mode is recorded in the audio object recording region 33, a very large number of pieces of music can be recorded. When each piece includes the time map information, the data amount of the audio file information table (AUDFIT) 43 becomes very large. There occurs a problem that burdens of the player increase. To avoid this problem, when the setting method of the start/end position of the cell shown in (i) in FIG. 2 is used in the present invention, it becomes unnecessary to dispose the time map information in the audio file information table (AUDFIT) 43. As a result, there is an effect that the data size of the management information recording region 30 can be reduced.

As shown in (j) in FIG. 2, cell block mode information 92 is recorded in a cell type C_TY 81 in the cell general information (C_GI) 76. As shown in (g) in FIG. 2, since the cell block mode information 92 in the cell information (CI) #1_62, #2_63, #5_66, #m_69 concerning a single cell not constituting the cell block does not constitute the cell block, “00” is recorded. As shown in (g) in FIG. 2, the cell information (CI) #3_64, #4_65, #6_67, #7_68 constitute the cell block. Since the cell information (CI) #3_64 and #6_67 are disposed in front (first) positions in the cell blocks #A_71 and #B_72, “01” is recorded in the cell block mode information 92. Since the cell information (CI) #4_65 and #7_68 are disposed in back (last) positions in the cell blocks #A_71 and #B_72, “11” is recorded in the cell block mode information 92. When the cell block mode information 92 is interpreted in this manner, the cell constituting the cell block and front/back arrangement in the cell block can be distinguished.

FIG. 2 shows a method of: constituting the cell block as the management information; and managing the information obtained by recording the distributed audio information (audio object) including the same contents in the audio object recording region 33 in different audio coding modes. The present invention is not limited to the management in the cell block. According to the scope of the present invention, there is also provided a method of: constituting a program block with respect to the program information (PGI) #1_51 to #n_52 shown in (f) in FIG. 2; disposing cell block mode information in program type information in the program information (PGI) #1_51 to #n_52 as not shown; and managing the program constituting the program block among the corresponding programs and the front/back arrangement in the program block.

As shown in (g) in FIG. 2, in the embodiment of the present invention, the cell information (CI) #3_64 and #4_65 corresponding to the cells constituting the same cell block #A_71 are securely continuously described in the PGC information (PGCI) 44. Moreover, in the same cell block #A_71:

(1) the cell information corresponding to the cell designating the audio information recorded in the common coding mode defined by the linear PCM or packed PCM is recorded in the first described cell information (CI) #3_64; and

(2) the cell information corresponding to the cell designating the audio information recorded in the unique coding mode defined by audio coding modes other than those of the linear PCM and packed PCM is recorded in the last described cell information (CI) #4_65.

Furthermore, the reproduction time of each cell constituting the same cell block #A_71 is set so that a deviation of one or more seconds is not generated. Thereby, even with the reproduction in any audio coding mode, a large deviation is not generated, and therefore uncertainty is not given to the user. Additionally, any one of the respective cells constituting the same cell block #A_71 belongs to the same program information (PGI) #1_51 to #n_52.

Moreover, for a plurality of cell blocks present in one program, with respect to the audio coding mode for the audio information designated by each cell in the same program:

(1) the mode may be different between the linear PCM and packed PCM for each cell in the connection of the common coding mode (i.e., it is permitted that the audio information designated by the cell of the first cell block is recorded in the linear PCM and that the audio information designated by the cell in the next cell block is recorded in the packed PCM); and

(2) all the audio coding modes of the audio information designated for each cell in the connection of the unique coding mode have to be the same audio coding mode in the same program (i.e., it is prohibited that the audio information designated by the cell of the first cell block is recorded in ATRAC3 and that the audio information designated by the cell in the next cell block is recorded in AC-3.

<Information Recording/Reproducing Apparatus According to the Present Invention>

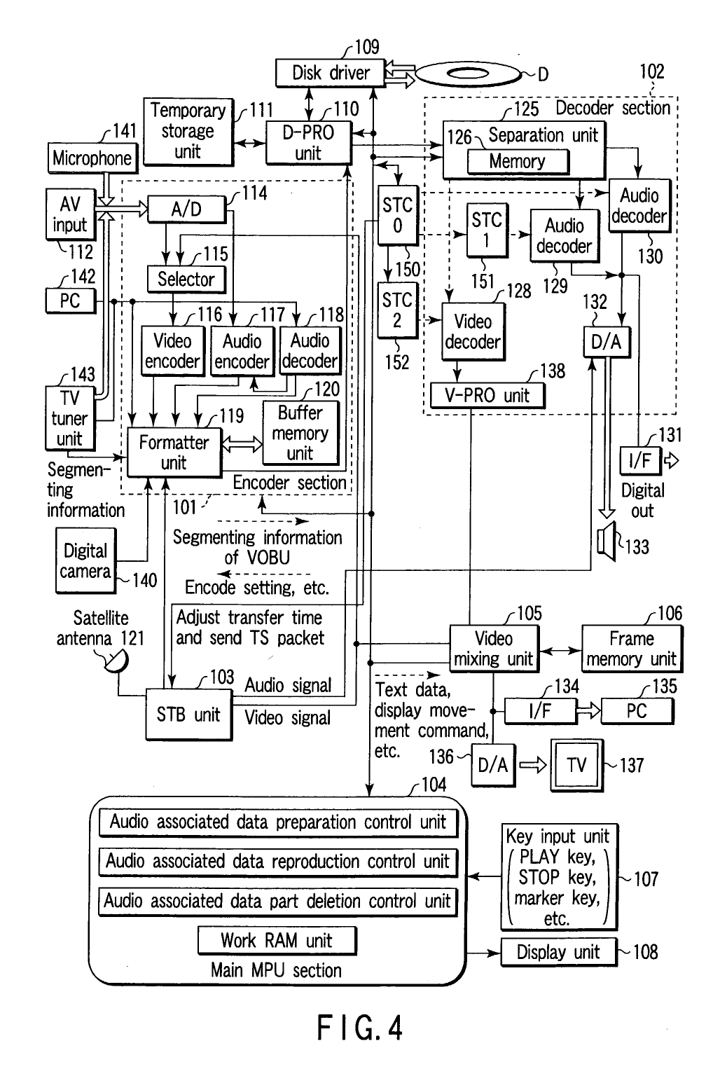

FIG. 4 shows a structure of an information recording/reproducing apparatus in the present invention.

Here, the information recording/reproducing apparatus includes a disk drive unit 109 which performs recording and reproducing with respect to the information storage medium D such as an optical disk. The apparatus further includes an encoder section 101 which uses the disk drive unit 109 to execute an encode process so as to record the information in the information storage medium D, and a decoder section 102 which uses the disk drive unit 109 to decode/process the readout information.

Moreover, for the information recording/reproducing apparatus, as an input section, a microphone 141, A/V input unit 112, personal computer (PC) 142, TV tuner unit 143, and digital camera 140 are connected, so that information to be handled is taken in.

Furthermore, there is disposed a set top box (STB) unit 103 which takes in a broadcasting signal via a satellite antenna 121, supplies an audio signal into the decoder section 102, and supplies a video signal to the encoder section 101 or a video mixing unit 105 described later. Additionally, the video mixing unit 105 which receives text data and display movement command is connected to each component via a control bus. The video mixing unit 105 is connected to a frame memory 106. Moreover, the video mixing unit 105 is connected to an external PC 135 via an interface 134. Furthermore, the mixing unit is connected to a display 137 via a D/A converter 136.

The disk drive unit 109 is connected to a data processing unit 110 as well as a primary storage unit 111 such as a cache, and performs data processing.

Each of these components is connected to a main microprocessor unit (MPU) section 104 which executes a whole control operation, for example, via a data bus. This function is divided into an audio associated data preparation control unit, audio associated data reproduction control unit, and audio associated data part deletion control unit, and includes a work RAM unit for operation. Furthermore, a key input unit 107 for performing operations such as recording/reproducing processes by the user, and a display unit 108 for displaying search information are connected to the main MPU section 104.

Furthermore, the data bus is connected to STC (system time counter or system time clock) 0 unit 150, STC2 unit 152, and connected to the decoder section 102.

Moreover, the encoder section 101 described above includes an A/D converter 114 which digitizes signals from the respective input units 140 to 143, selector 115 connected to the converter, video encoder 116 which receives a signal from the selector 115, audio encoder 117 which receives a signal from the A/D converter 114, and audio decoder 118 which receives a signal from the PC 142. Furthermore, the section includes a formatter unit 119 which receives the signals from the respective encoders 116, 117, and decoder 118 to perform a format process, and a buffer memory unit 120 connected to the formatter unit.

Furthermore, the decoder section 102 described above includes a separation unit 125 including a memory 126 connected to a data bus and data processing unit 110, separates the supplied signal into a plurality of audio signals, and supplies the signals to a plurality of audio decoders 129, 130. Additionally, the section is connected to a STC1 151 connected to the above-described STC0 150, and an output is connected to the audio decoder 129.

Additionally, the output of a video decoder 128 connected to the separation unit 125 is connected to a video processing unit 138, and the output is connected to the video mixing unit 105 described above. Moreover, the output of the audio decoder 130 is outputted to the outside via an interface 131. Furthermore, the outputs of the audio decoders 129, 130 are supplied to a D/A converter 132, and the output is outputted to an external speaker 133.

A recording operation in the information recording/reproducing apparatus constituted as described above will briefly be described hereinafter. That is, various types of object information inputted from various input units 140 to 142, 112, 113 are encoded by the encoder section 101, and then recorded on the information storage medium D via the disk drive unit 109. Additionally, the management information concerning the object information is prepared in the main MPU section 104, and recorded on the information storage medium D via the disk drive unit 109. The audio information distributed from the audio contents provider PD via a network is inputted via the personal computer (PC) 142. To record the distributed information in the audio coding mode as such, the audio object (sound) information transferred from the PC 142 is transferred to the formatter unit 119 as such. To change the audio coding mode at the distribution time, the information is once decoded (returned to a base band) by the audio decoder 118, and transferred to the audio encoder 117 so that the audio coding mode is converted.

Moreover, an outline of the reproduction process will briefly described. That is, at a reproduction time the management information recorded in the information storage medium D is temporarily recorded in the work RAM unit in the main MPU section 104 via the disk drive unit 109. The management information temporarily recorded in the work RAM unit is used to read the object information as a reproduction object recorded on the information storage medium D. The information is decoded in the decoder section 102, and then outputted to the speaker 133, TV 137, or display unit 108. The audio decoder 130 has a function of decoding the linear PCM and packed PCM as the common audio coding mode, and the audio decoder 129 has a decode function of reproducing (decoding) the unique audio coding mode of the information reproduction apparatus of the present invention.

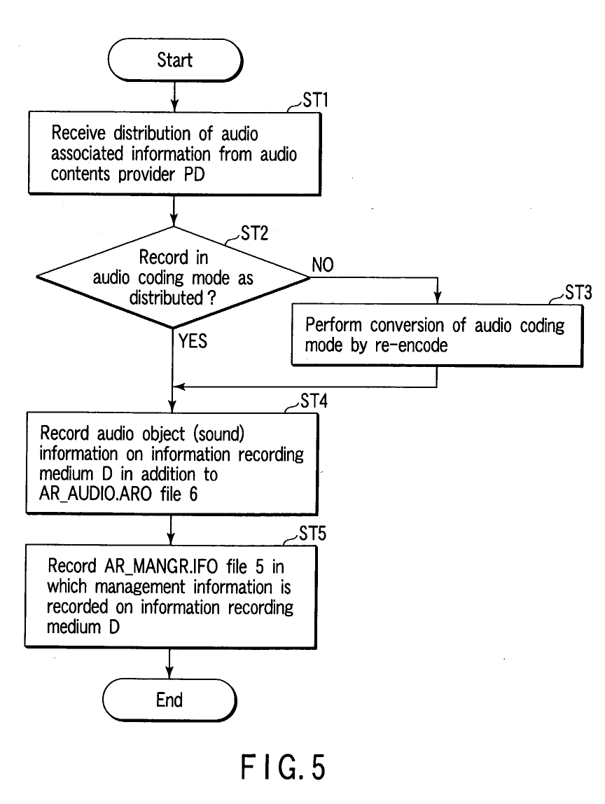

A recording method in the information recording/reproducing apparatus of the present invention will next be described with reference to a flowchart of FIG. 5. FIG. 5 shows a flowchart of the recording method in the information recording/reproducing apparatus of the present invention. First, the audio contents provider PD distributes the audio information of the fifth piece of music in the unique audio coding mode α as shown in FIG. 1 (ST1). Then, the information is transferred into the information recording/reproducing apparatus via the PC 142 as shown in FIG. 4. The main MPU section 104 judges whether or not the information is recorded in the audio coding mode as distributed (ST2). If it is necessary to record the fifth piece in the common audio coding mode β, the audio information is transferred to the audio decoder 118 (ST3), once decoded into the base band, re-encoded into the common audio coding mode β in the audio encoder 117, and recorded in the information storage medium D (ST4). When the recording of the audio object (sound) information ends, the management information shown in FIG. 2 constituting the cell block is prepared by the main MPU section 104 in accordance with a re-encoding situation. The information is recorded as an AR_MANGR.IFO file 5 (and AR_MANGR.BUP file 6 as the backup file) on the information storage medium D (ST5).

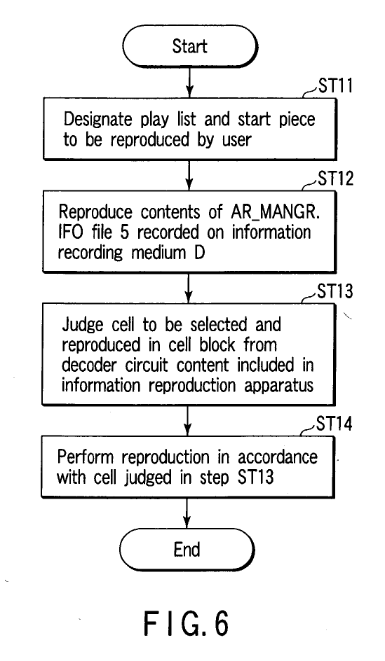

A reproduction method in the information recording/reproducing apparatus of the present invention will next be described with reference to a flowchart of FIG. 6. FIG. 6 shows a flowchart concerning the reproducing method in the information recording/reproducing apparatus of the present invention. When the user designates a play list to be reproduced and piece of music to be first reproduced (ST11), the disk drive unit 109 reproduces the AR_MANGR.IFO file 5 already recorded on the information storage medium D (ST12), and interprets a combination of cell blocks. It is next judged which cell in the cell block is to be reproduced from a decoder circuit content included in the information recording/reproducing apparatus (i.e., whether to use the common audio coding mode β or the unique audio coding mode α) (ST13). To reproduce the information in the unique audio coding mode α, the corresponding portion of the AR_AUDIO.ARO file 6 already recorded on the information storage medium D is successively reproduced along the play list designated by the user, successively decoded by the audio decoder 129 shown in FIG. 4, and outputted.

To reproduce the information in the common audio coding mode α, pieces which can be reproduced in the common audio coding mode β using the cell block information 72 (third and fifth pieces among the first to fifth pieces in the embodiment of FIG. 1) are selected. Additionally, recorded portions in the AR_AUDIO.ARO file 6 are searched. Accordingly, the disk drive unit 109 picks/reads the information in scattered positions on the information storage medium D based on the control of the main MPU section 104. The information is decoded by the audio decoder 130 and outputted (ST14).

As described above, according to the data structure of the audio associated information according to one embodiment of the present invention, even the audio information which has heretofore been recorded in a special coding mode having no compatibility among the players is decoded together by the coding mode having the compatibility, and recorded onto the information storage medium D such as the optical disk. Thereby, even when the audio information recorded in the information storage medium D is reproduced, the information can be reproduced in the original coding mode. Additionally, it is possible to reproduce the information in the coding mode of the linear PCM by which any player can reproduce the information and which has the compatibility.

<Program of Information Recording/Reproducing Apparatus According to the Present Invention>

The above-described information reproduction apparatus and information recording apparatus of the music associated information according to one embodiment of the present invention can be realized as program executed on a personal computer (PC) on which, for example, operation systems (OS) such as Windows are mounted. In this case, the operation in accordance with the flowchart of FIGS. 5 and 6 is constituted as the computer program. When the program is installed in the PC, the above-described information reproduction process and information recording process are realized as one application on the PC.

This program can be handled as a state recorded in information recording mediums such as the disk as usual. Furthermore, for example, the user directly accesses a site of a provider of the cell, so-called home page via networks such as Internet, and downloads program data into user's PC so that the program can be provided.

By various embodiments described above, a person skilled in the art can realize the present invention, but it is easy for the person skilled in the art to further think upon various modification examples of these embodiments. It is possible to apply the present invention to various embodiments without any inventive ability. As described above, the present invention covers a broad range consistent with disclosed principle and inventive characteristics, and is not limited to the above-described embodiments.

As described above in detail with reference to the drawings, according to one embodiment of the present invention, a first coding mode is set so as to have uniqueness among different information reproduction apparatuses (i.e., impossible reproduction is permitted in a specific information reproduction apparatus). A second coding mode is set so as to secure compatibility among the different information reproduction apparatuses (possible reproduction is indispensable in all the information reproduction apparatuses). In this case, the obtained audio information coded in the unique coding mode can be recorded in the information storage medium in the first coding mode as such. Additionally, the information is simultaneously recorded in the information storage medium even in the second coding mode in which the compatibility is secured. Thereby, the same audio information can be reproduced even in another information reproduction apparatus, and reproduction compatibility of the information storage medium can be assured.

What is claimed is:

1. An information storage medium in which audio associated information is recorded and music associated information is recorded, the music associated information comprising:
a recording region in which at least audio information is recorded, the recording region including a first recording region in which the audio information coded by a first coding mode is recorded and a second recording region in which the audio information coded by a second coding mode different from the first coding mode is recorded; and
a management region in which management information concerning the recording region is recorded and which includes reproduction procedure information indicating a reproduction procedure of the audio associated information, the reproduction procedure information indicating the reproduction procedure of the audio information by connection of reproduction units and in which the audio information is managed as the reproduction units different from one another in the first and second recording regions and which includes coding mode information to be referred to in reproducing the audio information.

2. The information storage medium according to claim 1, wherein the music associated information including information of the reproduction units of pairs different from one another is recorded in the reproduction procedure information of the management region.

3. The information storage medium according to claim 1, wherein the music associated information including information of the reproduction units of pairs different from one another is recorded in the reproduction procedure information of the management region in accordance with the first and second coding modes.

4. An information reproduction method of reproducing music associated information recorded in an information storage medium, comprising:
a readout step of reading information from the information storage medium in which the music associated information is recorded, the information including a recording region in which at least audio information is recorded, the recording region including a first recording region in which the audio information coded by a first coding mode is recorded and a second recording region in which the audio information coded by a second coding mode different from the first coding mode is recorded, and a management region in which management information concerning the recording region is recorded and which includes reproduction procedure information indicating a reproduction procedure of the audio associated information, the reproduction procedure information indicating the reproduction procedure of the audio information by connection of reproduction units and in which the audio information is managed as the reproduction units different from one another in the first and second recording regions and which includes coding mode information to be referred to in reproducing the audio information; and
a reproduction step of reproducing at least one of the audio information coded by the first coding mode and recorded in the first recording region and the audio information coded by the second coding mode and recorded in the second recording region based on read information read by the readout step.

5. The information reproduction method according to claim 4, wherein the music associated information including information of the reproduction units of pairs different from one another is recorded in the reproduction procedure information of the management region of the information storage medium.

6. The information reproduction method according to claim 4, wherein the music associated information including information of the reproduction units of pairs different from one another is recorded in the reproduction procedure information of the management region of the information storage medium in accordance with the first and second coding modes.

7. An information recording method of receiving music associated information and recording the music associated information in an information storage medium, comprising:
a generation step of receiving the music associated information including audio information coded in a first coding mode, and generating the audio information coded by a second coding mode different from the first coding mode based on the music associated information; and
a recording step of recording the music associated information including a recording region in which at least audio information is recorded, the recording region including a first recording region in which the audio information coded by the first coding mode is recorded and a second recording region in which the audio information coded by the second coding mode is recorded, and a management region in which management information concerning the recording region is recorded and which includes reproduction procedure information indicating a reproduction procedure of the audio associated information, the reproduction procedure information indicating the reproduction procedure of the audio information by connection of reproduction units and in which the audio information is managed as the reproduction units different from one another in the first and second recording regions and which includes coding mode information to be referred to in reproducing the audio information into the information storage medium based on the audio information generated by the generation step and coded by the second coding mode and the audio information coded by the first coding mode.

8. The information recording method according to claim 7, wherein the music associated information including information of the reproduction units of pairs different from one another is recorded in the reproduction procedure information of the management region of the information storage medium.

9. The information recording method according to claim 7, wherein the music associated information including information of the reproduction units of pairs different from one another is recorded in the reproduction procedure information of the management region of the information storage medium in accordance with the first and second coding modes.
